(19) United States
(12) Patent Application Publication
(10) Pub. No.: US 2002/0050018 A1
(43) Pub. Date: May 2, 2002

(54) Windshield wiper with pressurizing function

(76) Inventor: Tony Huang, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/805,050

(22) Filed: Mar. 14, 2001

(30) Foreign Application Priority Data
Nov. 2, 2000 (TW) 89219031

(51) Int. Cl. B60S 1/38

(52) U.S. Cl. 15/250.44; 15/250.46

(57) ABSTRACT

This invention is about a windshield with pressurizing function. The wiper has a long wiper holder including a big frame, two medium-sized frames and 2 small frames, arranged in layers. Other parts include a scraping plate, installed at one side of the wiper holder. The features of this wiper are that it has four springs. Two springs are installed in between the two medium-sized frames and the scraping plate. The other two springs are installed in between the big frame and the two small frames.

### BACKGROUND OF THE INVENTION

This invention is about windshield wiper, especially a wiper with pressurizing function.

A wiper that is closely attaching to the windshield has a better performance in cleaning. In order to achieve this goal, some wipers have added pressurizing boards on the frame. When cars move fast, the air pressure will cause a pressure on the wipers. Then, the above goal is achieved. However, such kind of products can only be effective when cars move above a certain speed to create enough air pressure. If cars move slowly or are not moving, this kind of product will not show any pressurizing effect.

Therefore, the purpose of this invention is to provide a pressurizing function that can show the effect no matter whether the car is moving or not. Such a pressurizing function can add pressure to the scraping plate on a wiper to strengthen its performance.

In order to achieve the goal mentioned above, this invention with pressurizing function has a long wiper holder, at least a scraping plate, installed at one side of the wiper holder. The features of this wiper are that it has at least one flexible part, installed in between the wiper holder and the scraping plate. The purpose of this flexible part exists to exert a certain degree of pressure to support the scraping plate.

### OUTLINING DIAGRAMS

The following includes three examples of this wiper in use. Together with illustrations, the instructions will describe the goal, effect and features of this invention.

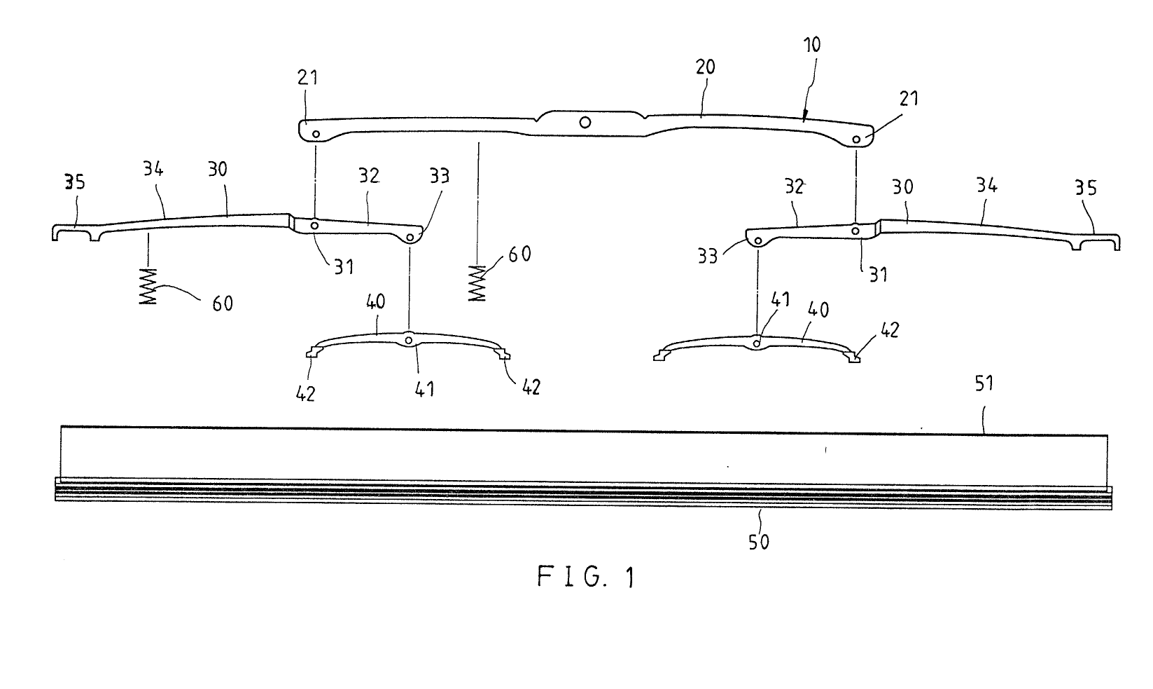

FIG. 1 is a diagram of the first example of use in decomposition form.

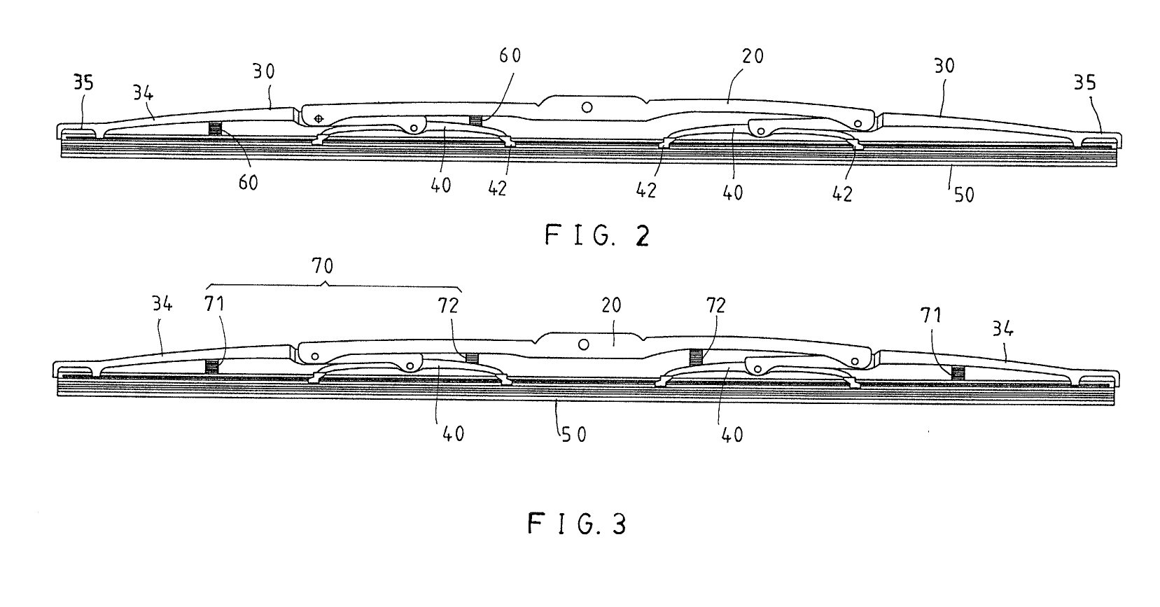

FIG. 2 is a front view of the first example of use.

FIG. 3 is the front view of the second example of use.

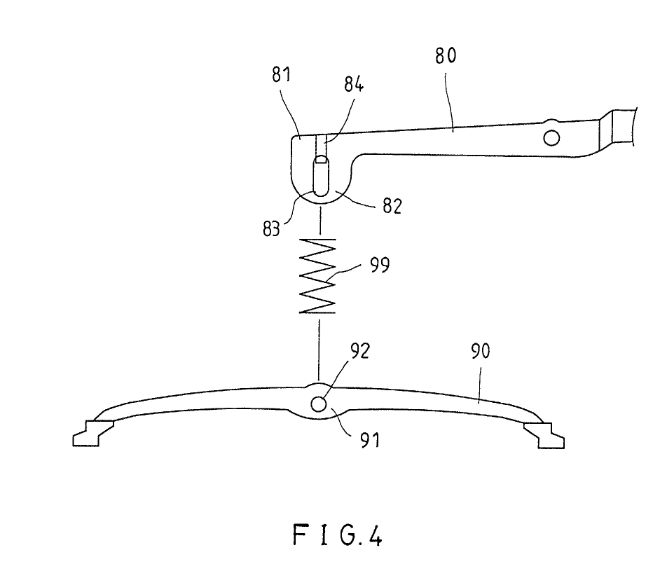

FIG. 4 is the enlarged segment of the third example of use in decomposition form.

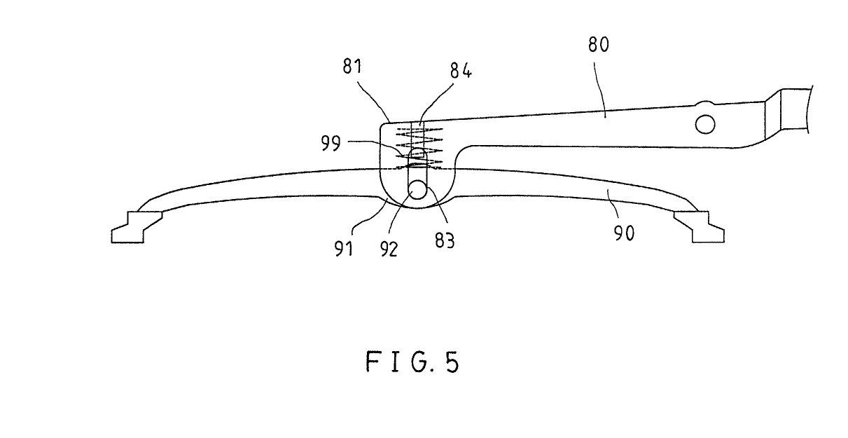

FIG. 5 is the enlarged diagram of the third example of use.

### DETAILED DESCRIPTION

Please refer to the FIG. 1 and FIG. 2. This invention of wiper with pressurizing function has the following parts:

It first includes a long wiper holder (10). This part is used to connect to the wiper support on a car. This wiper holder is made of many long frames arranged in layers. In this example, this part is made of one big frame (20), two medium-sized frames (30) and two small frames (40). Moreover, both ends of the big frame have a connecting section (21). In the middle of the two medium-sized frames, there are two connecting sections (31). This connecting section (31) is connected to the connecting section (21) in the big frame. The short-arm end (32) on the two medium-sized frames has a connecting section (33). The long-arm end (34) on the two medium-sized frames has a clipping section (35). In the middle of the two small frames, there are two connecting sections (41). This connecting section (41) is connected to the connecting section (33) on the short-arm end of the medium-sized frame. Both ends of the small frame have a clipping section (42). This structure is similar to that of traditional style.

The wiper also has a scraping plate, installed on one side of the wiper holder (10). On the clipping section of medium-sized frames (30) and small frames (40), there is a pressurizing board (51) on the scraping plate. This is also similar to the design of the traditional style.

The features are:

There are two flexible parts (60), as shown in FIG. 1 and FIG. 1. In this example of use, the two flexible parts are two springs. One spring is installed in between the long-arm end (34) of the medium-sized frame and the scraping plate (50). Another spring is located in between the big frame (20) and the small frame (40)

Through the structure described above, in addition to the pressure from the original wiper support, spring (60) can provide an appropriate degree of holding pressure to support the scraping plate (50). Such a structure will increase the pressure the scraping plate exerts onto the windshield and then force the scraping plate to move more closely to the windshield surface when it is in use. This will achieve the goal of improving the performance of wiper.

Furthermore, this invention can have four symmetrically installed springs (70) to be on both sides of the wiper holder (10), as shown in FIG. 3. FIG. 3 is the second example of use. In FIG. 3, two springs (71) are installed in between the long-arm ends of the two medium-sized frames and the scraping plate (50). In addition, the other two springs are located in between the big frame (20) and two small frames (40). Such a structure can exert pressure to the scraping plate in a more balanced way so that scraping effect will be better.

In addition, FIG. 4 and FIG. 5 show the third example of this invention in use. The connecting section (81) on the two medium-sized frames (80) has two protruding sections (82) facing downwards. Both protruding boards have a long-shape hole (83). In between the two protruding boards, there is a protruding post (84). The connecting section (91) in between the two small frames (90) has two holes (92). Use a pivotal bolt (93) to go through the two long-shape holes (83) and the holes (92) on the small frames so that the small frames will be connected to the two medium-sized frames (80). This arrangement will enable the small frames to have the room to move up and down along the long-shape hole (83). On the wiper support, there are four springs (99). Two springs are installed in between the long-arm end on the two medium-sized frames and the scraping plate, similar to the structure of the second example. The other two springs are used to cover the protruding posts (84) on the two medium-sized frames (80). Then, these two springs will be installed to the connecting section in between the two small frames (90) and the two medium-sized frames (80) to prop up both the top of the small frame and the bottom of the medium-sized frame. This arrangement will force the small frame (80) to be far away from the connecting section of the medium-sized frame under regular circumstances. Then, the pressure on the scraping plate under the two small frames will increase in a balanced way. Moreover, this arrangement will strengthen the cleaning effect of the wiper.

The following is simple illustration of the figures:

FIG. 1 is a diagram of the first example of use in decomposition form.

FIG. 2 is a front view of the first example of use.

FIG. 3 is the front view of the second example of use.

FIG. 4 is the enlarged segment of the third example of use in decomposition form.

FIG. 5 is the enlarged diagram of the third example of use.

1. A wiper with pressurizing function including:
a long wiper holder;
at least one wiper scraping plate, installed on one side of the wiper holder; with the features of:
at least one flexible part, installed in between the wiper holder and the scraping plate, to exert an appropriate degree of pressure to prop up the scraping plate.

2. A wiper with pressurizing function including:
a long wiper holder, connected by layers of frames;
at least one wiper scraping plate, installed on one side of the wiper holder; with the features of:
at least one flexible part, installed in between the top layer of frame and the lower layer of frame to exert an appropriate degree of pressure to prop up the scraping plate.

3. A wiper with pressurizing function including:
a long wiper holder, connected by layers of frames;
at least one wiper scraping plate, installed on one side of the wiper holder; with the features of:
at least two flexible parts. One part is installed in between the top layer of frame and the lower layer of frame and the other is installed in between the wiper holder and the wiper scraping plate to exert an appropriate degree of pressure to prop up the scraping plate.

4 A wiper with pressurizing function including:
a long wiper holder, connected by layers of frames;
at least one wiper scraping plate, installed on one side of the wiper holder;
with the features of:
at least one flexible part, installed on the connecting section between the top layer of frame and the lower layer of frame to force the lower frames to be far away from the connecting section of the upper frames under regular circumstances.

5. The same as the wiper with pressurizing function mentioned in claim 4, the connecting section on the upper frames has two long-shape holes and the lower layer of frame is fixed to the long-shape holes and can move along the long-shape holes.

6. The same as the wiper with pressurizing function mentioned in claim 5, the connecting sections on the upper layer of frames have two protruding sections facing downwards, both protruding boards have long-shape holes, in between the two protruding boards, there is a protruding post. The connecting sections on the lower layer of frames have two holes; use a pivotal bolt to go through the two long-shape holes and the holes on the lower layer of frames to fix the lower layer of frames to the upper layer of frames, the flexible parts will be used to cover the protruding posts on the upper layer of frames and then be installed to the connecting section on the lower layer and upper layer of frames to prop up both the top of the lower layer frames and the bottom of the upper layer frame.
